(19) United States
(12) Patent Application Publication
(10) Pub. No.: US 2004/0243809 A1
(43) Pub. Date: Dec. 2, 2004

(54) Method and system for verifying electronic signatures and electronic signature device

(76) Inventors: Vesa M. Torvinen, Helsinki (FI); Kent Bogestam, Hagersten (SE)

Correspondence Address: NIXON & VANDERHYE, PC, 1100 N GLEBE ROAD, 8TH FLOOR, ARLINGTON, VA, 22201-4714, US

(21) Appl. No.: 10/482,930

(22) PCT Filed: Jul. 8, 2002
(86) PCT No.: PCT/FI02/00618

(30) Foreign Application Priority Data
Jul. 9, 2001 (FI) 20011498

(51) Int. Cl. H04L 9/00

(52) U.S. Cl. 713/176

(57) ABSTRACT

The present invention relates in general to electronic commerce realized in communications networks and more specifically to a new type of method and a new type of system for verifying electronic signatures and to a new type of electronic signature device. The solution according to the present invention provides additional flexibility and is still providing a simple solution in which also unstructured data can be used and utilized.

### TECHNICAL FIELD OF THE INVENTION

The present invention relates in general to electronic commerce realized in communications networks and more specifically to a new type of method and a new type of system for verifying electronic signatures and to a new type of electronic signature device.

### BACKGROUND OF THE INVENTION

The background of the invention is discussed briefly in the following. Different kinds of signature devices are used for producing and verifying electronic signatures. These signatures have legal status and consequently they are used in producing different kinds of electronic contracts e.g. electronic payments.

Computers process and interpret these contracts automatically and make decisions about delivery and rejection of different kinds of services. These kinds of systems are often assumed to use structured data, such as WTLS, HTML or XML, in order to facilitate automatic processing of electronic contracts.

The problems of the prior art are discussed briefly in the following. Electronic verification systems typically are assumed to use structured data in order to facilitate automatic processing of electronic contracts. However, data used in electronic contracts need not to be structured. Especially, in case of audio, visual or unstructured text the interpretation can often be made only by human being with appropriate time and cost. The problem is that computers cannot interpret the data. Furthermore, unstructured data is not often considered for use because it is assumed to be useless.

One example is a prior art mobile commerce application in which mobile devices are used for producing electronic signatures. Typically these applications use “browser approach” in which the communication is based on structured electronic text. They assume that people have to read the contract before signing and then some computer program has to interpret the content of the signed message.

Furthermore, most mobile devices suffer from small displays. This is a problem because legislation requires that everything that is electronically signed by some signing device must be presented to the signatory prior to the signature creation. If the data to be signed is long and the display of the mobile device is small, the presentation of data to the signatory is very problematic.

In regard to prior art reference is made to international patent application WO 99/49404, which presents a method for preparation of an invoice which the user signs using his telephone calling card and a pin code. Furthermore, in regard to prior art reference is made to European patent application EP 859500, which presents a method and apparatus directed to speaking information which would normally be displayed, on a user's device lacking a display screen. Furthermore, in regard to prior art reference is made to international patent application WO 00/50984, which presents a browser having a voice output for speaking the content of pages being navigated.

### SUMMARY OF THE PRESENT INVENTION

It is an object of the present invention to overcome or at least mitigate the disadvantages of the prior art. The present invention provides a method and a system for verifying electronic signatures and an electronic signature device.

According to a first aspect of the present invention there is provided a method for verifying electronic signatures, the method having a signatory with a terminal device, a content provider, and a payment provider for the signatory, wherein the signatory signs data files containing unstructured electronic data presenting a contract in the form of one or a combination of at least two of the elements of voice, still picture, moving picture and unstructured text.

More preferably, the method comprises the steps of

the content provider presenting said data files to the signatory,

the signatory accepting the contract by signing said data files,

the signatory returning the signed data files to the content provider,

the content provider sending the signed data files together with the charged amount in structured machine-readable format to the payment provider, and

the payment provider storing the signed data files and redacting the charged amount from the account of the user.

More preferably, in the method, prior to having the contract presented the signatory listens to or reads an advertisement of the content provider and selects a service with his terminal device. More preferably, prior to having the contract presented the content provider sets up a payment connection with the payment provider.

More preferably, in the method, the content provider sends the unstructured data and the structured data combined together to the payment provider. More preferably, the content provider sends the unstructured data and the structured data linked together to the payment provider. More preferably, the structured data has a pointer to the unstructured data.

More preferably, in the method, the content provider sends the unstructured data and the structured data in separate messages to the payment provider. More preferably, content provider stores unstructured data and only sends the structured data to the payment provider.

More preferably, in the method, the verifier of the signature is the original source of the data that is signed. More preferably, the signatory interprets the content of the unstructured data before signing.

Preferably, in the method, the signatory applies the electronic signature over unstructured data files. Alternatively, the signatory applies the electronic signature over unstructured data files and additional attributes. Alternatively, the signatory applies the electronic signature over unstructured data files and structured data files.

Preferably, in the method, the signatory applies the electronic signature using a private signature key. Alternatively, the signatory applies the electronic signature using a mobile device. Alternatively, the signatory applies the electronic signature using a personal computer. Alternatively, the signatory applies the electronic signature using television equipment.

According to a second aspect of the present invention there is provided a system for verifying electronic signatures, the system having a signatory with a terminal device, a content provider, and a payment provider for the signatory, wherein the system has an electronic signature device equipped for the signatory to sign data files containing unstructured electronic data presenting a contract in the form of one or a combination of at least two of the elements of voice, still picture, moving picture and unstructured text.

Preferably, the system has:

means for the content provider to present said data files to the signatory,

means for the signatory to accept the contract by signing said data files,

means for the signatory to return the signed data files to the content provider,

means for the content provider to send the signed data files together with the charged amount in structured machine-readable format to the payment provider,

means for the payment provider to store the signed data files and to redact the charged amount from the account of the user.

More preferably, the system has means for the signatory to listen to or to read an advertisement of the content provider and to select a service with his terminal device prior to having the contract presented.

More preferably, the system has means for the content provider to set up a payment connection with the payment provider prior to having the contract presented. More preferably, the system has means for the content provider to send the unstructured data and the structured data combined together to the payment provider.

More preferably, the system has means for the content provider to send the unstructured data and the structured data linked together to the payment provider. More preferably, the structured data has a pointer to the unstructured data.

More preferably, the system has means for the content provider to send the unstructured data and the structured data in separate messages to the payment provider. Alternatively, the system has means for the content provider to store unstructured data and only to send the structured data to the payment provider.

More preferably, in the system, the verifier of the signature is the original source of the data that is signed. More preferably, the unstructured data files that are to be signed are stored into the Contract Database. Alternatively, the unstructured data files that are to be signed are stored on Service Platform.

Preferably, the system has means for the signatory to interpret the content of the unstructured data before signing. More preferably, the unstructured data files are sent to the signatory via a mobile network. Alternatively, the unstructured data files are sent to the signatory via Internet. Alternatively, the unstructured data files are sent to the signatory via a television network. Alternatively, the unstructured data files are sent to the signatory via a Wireless Local Area Network. Alternatively, the unstructured data files are sent to the signatory via a Bluetooth connection. Alternatively, the unstructured data files are sent to the signatory via an IrDa connection.

More preferably, in the system, the unstructured data files are presented to the signatory via a media player. More preferably, the media player is complemented with Bluetooth functionality. Alternatively, the media player is complemented with IrDa functionality.

More preferably, in the system, the signatory applies the electronic signature over unstructured data files. Alternatively, the signatory applies the electronic signature over unstructured data files and additional attributes. Alternatively, the signatory applies the electronic signature over unstructured data files and structured data files.

More preferably, in the system, the signatory applies the electronic signature using a private signature key. More preferably, the signature verifier has interpretation/validation means for interpreting and validating the signed contract.

More preferably, in the system, the signature verifier has informing means to inform the Service Platform about the status of the contract. More preferably, the signature verifier has reporting means to inform the signatory about the validation of the contract.

More preferably, in the system, the signatory applies the electronic signature using a mobile device. Alternatively, the signatory applies the electronic signature using a personal computer. Alternatively, the signatory applies the electronic signature using television equipment.

According to a third aspect of the present invention there is provided a electronic signature device for signing electronic signatures in a system for verifying electronic signatures, the system having a signatory with a terminal device, a content provider, and a payment provider for the signatory, wherein the electronic signature device is equipped for the signatory to sign data files containing unstructured electronic data presenting a contract in the form of one or a combination of at least two of the elements of voice, still picture, moving picture and unstructured text.

Preferably, in the device, the verifier of the signature is the original source of the data that is signed. More preferably, the device has means for the signatory to interpret the content of the unstructured data before signing.

Preferably, in the device, the unstructured data files are sent to the signatory via a mobile network. Alternatively, the unstructured data files are sent to the signatory via Internet. Alternatively, the unstructured data files are sent to the signatory via a television network. Alternatively, the unstructured data files are sent to the signatory via a Wireless Local Area Network. Alternatively, the unstructured data files are sent to the signatory via a Bluetooth connection. Alternatively, the unstructured data files are sent to the signatory via an IrDa connection.

Preferably, the device has an integrated media player for presenting the unstructured data files to the signatory. More preferably, the media player is complemented with Bluetooth functionality. Alternatively, the media player is complemented with IrDa functionality.

Preferably, in the device, the signatory applies the electronic signature over unstructured data files. Alternatively, the signatory applies the electronic signature over unstructured data files and additional attributes. Alternatively, the signatory applies the electronic signature over unstructured data files and structured data files. More preferably, the signatory applies the electronic signature using a private signature key.

Preferably, the device is a mobile terminal. More preferably, the device is complemented with a mobile handsfree device. Alternatively the device is implemented in a mobile handsfree device.

### DETAILED DESCRIPTION OF CERTAIN EMBODIMENTS

A solution to the problem is an integrated signature and media-playing device and a method and a system for verifying unstructured data signed with the device. Instead of signing structured data, the signatory is signing data files, which contain unstructured electronic data presenting a contract in the form of voice, video or unstructured text.

In the method, verifier is the original source of the data. In other words, verifier already knows the content even though verifier's computer is not able to interpret the content automatically. The contract is presented to the signatory in required format e.g. unstructured text, audio or video. Signature is applied over unstructured data files and some supplemented attributes.

Solution is a communication protocol, which can be applied in several environments. With the help of the solution according to the present invention unstructured data can be used in a mobile commerce application in which mobile devices are used for producing electronic signatures. In a solution according to the present invention other mechanisms of presenting the content of the contract to the end-user than only structured electronic text are used appropriately.

### BRIEF DESCRIPTION OF THE DRAWINGS

For a better understanding of the present invention and in order to show how the same may be carried into effect reference will now be made to the accompanying drawings, in which:

FIG. 1 illustrates the initialisation of the system for verifying electronic signatures according to the present invention,

FIG. 2 illustrates the implementation of the method and system for verifying electronic signatures according to the present invention.

FIG. 3 illustrates an embodiment of the solution for verifying electronic signatures according to the present invention.

FIG. 4 illustrates another embodiment of the solution for verifying electronic signatures according to the present invention.

FIG. 5 illustrates a signalling diagram of one embodiment of the solution for verifying electronic signatures according to the present invention.

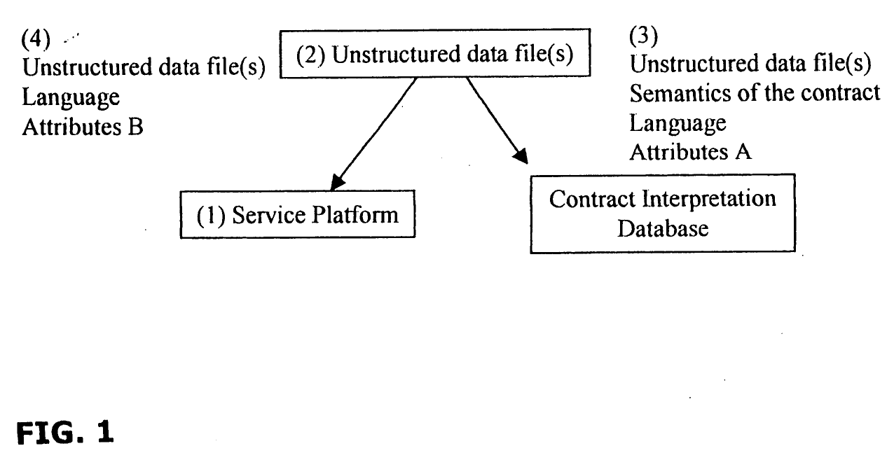

FIG. 1 illustrates the initialisation of the system for verifying electronic signatures according to the present invention. In the following steps 1-4 the system initialisation is described:

1) A service platform provides some services. The access to the service requires a valid digital signature to a contract, which has been specifically designed for this service. The contract may be a financial obligation, which is recorded in MP3 audio file format, for example.

2) The contents of the contracts are recorded into unstructured data files by using appropriate media e.g. human voice. The use of several languages requires separate contracts and data files.

3) Unstructured data files, semantics of it, language information and attributes (A) are stored into the Contract Interpretation Database.

4) Unstructured data files, language information and attributes (B) are stored on Service Platform.

In proposed environment, computer cannot interpret the content of the signed data easily. However, signatory as a human being is able to interpret the content easily simply by reading the unstructured text, looking at a picture, watching a video, listening a peace of audio data, or doing a combination of the above before signing. Computers interpret the content by using their prior information.

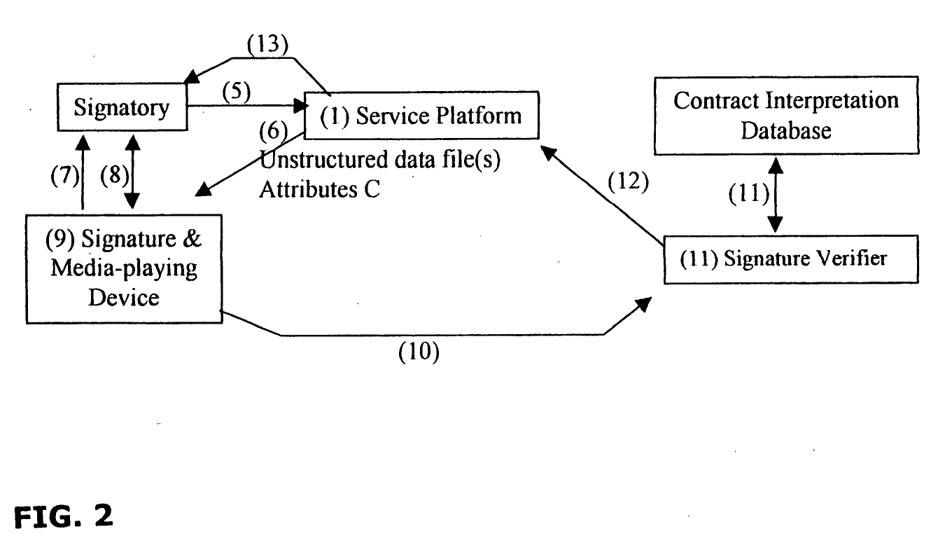

FIG. 2 illustrates the implementation of the method and system for verifying electronic signatures according to the present invention. In the following steps 5-13 the implementation of the method and system is described:

5) Signatory requests a service from the Service Platform by identifying the language and service.

6) Unstructured data files, and attributes (C) related to the service are sent to the Signature & Media-playing Device of the signatory. Communication channel could be mobile network or Bluetooth connection, for example.

7) Signatory interprets the content of the unstructured data files and other attributes from the Signature & Media-playing Device and either rejects or accepts the content.

8) If the contract is accepted, the signature device authenticates the signatory.

9) After successful authentication, the Signature & Media-playing Device digitally signs the unstructured data files and some complementary attributes, e.g. including attributes received from the Service Platform and the identifier for signatory's certificate, using private signature key.

10) Signature & Media-playing Device sends the signature together with complementary attributes to the Signature Verifier. Routing can be done directly or via Service Platform.

11) Signature Verifier interprets the semantics of the contract from the Contract Interpretation Database. The hash values may be used to help the comparison and integrity checks. Signature Verifier also interprets other signed attributes, such as the certificate identifier of the entity, and operates according to the valid security policy when checking the validity of the contract and signatory identity.

12) Signature Verifier informs the Service Platform about the status of the contract.

13) Service Platform delivers the service and a possible receipt to the Signatory if the contract is valid.

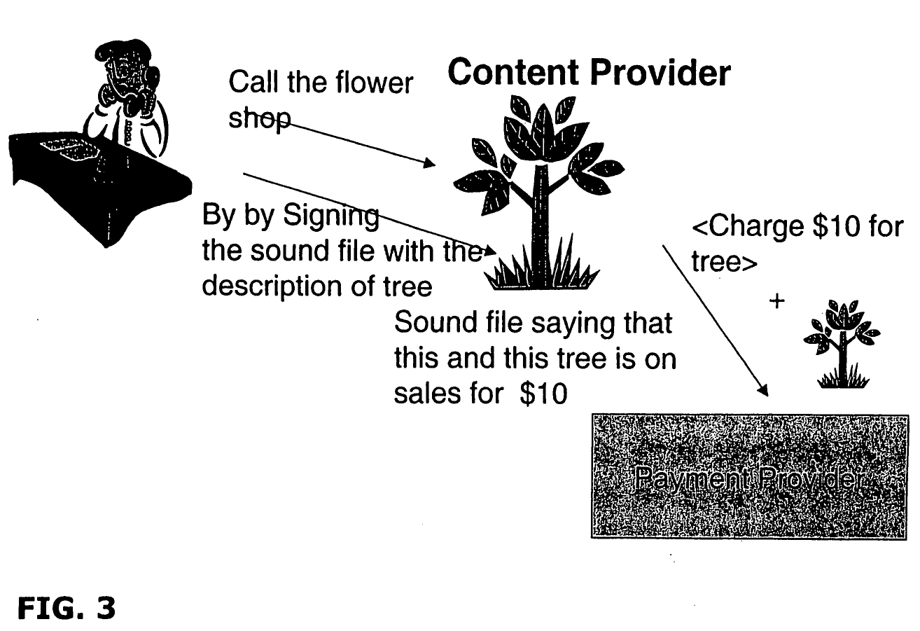

FIG. 3 illustrates an embodiment of the solution for verifying electronic signatures according to the present invention.

In the example according to the present invention a customer i.e. user calls a content provider e.g. a flower shop. In this example the customer can also be a blind person. The user then listens to an advertisement recording of the flower shop. The advertisement recording presents a special offer to the user e.g. that a small oak tree 30 cm tall is for sale for $10.

Having listened the advertisement recording of the flower shop the user can select the interesting offer by clicking on a button in the phone terminal. Content provider i.e. the flower shop then presents a recording with a contract for the purchasing of the product i.e. the requested tree. The contract recording can e.g. present a description of the purchased product and the terms of the sale of the product.

Having listened the contract recording of the flower shop the user then accepts the purchasing contract by signing the listened contract recording. So the user buys the advertised offer i.e. the tree by signing the sound file having the description of a tree. Signing can be done e.g. by entering his personal pin code.

Having received the user acceptance, the content provider sends the signed voice file and the charged amount in machine-readable format to a payment provider. The content provider can also send to the payment provider a pointer to a voice message together with the charged amount. The signature of the user i.e. the personal pin code is sent and stored beforehand at the payment provider. The payment provider then provides a payment to the content provider, and accordingly the content provider then provides the purchased product i.e. the tree to the user.

If the purchased product i.e. the tree delivered now diverge from the tree in the voice message the user can complain as the message describes what he has bought.

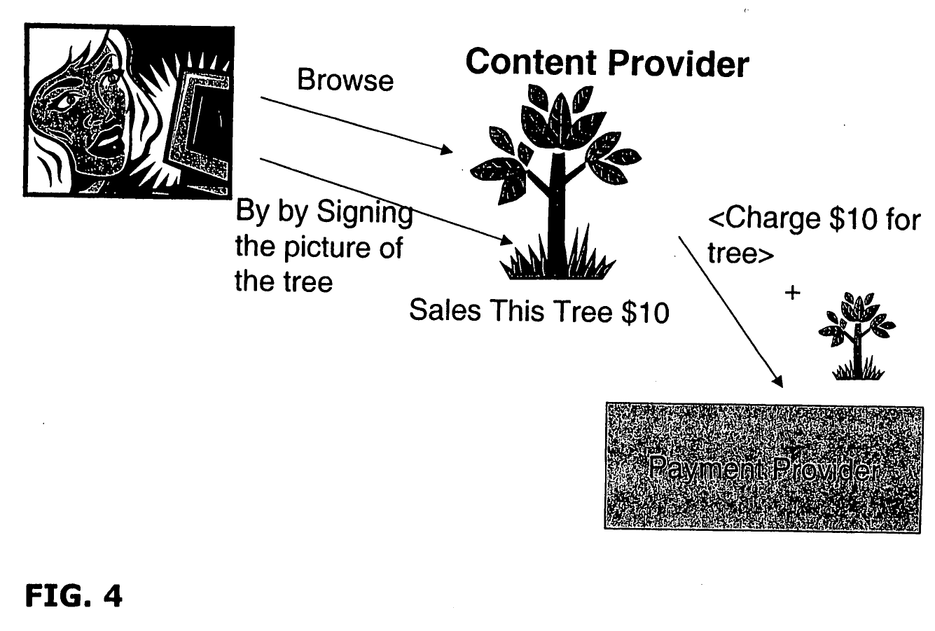

FIG. 4 illustrates another embodiment of the solution for verifying electronic signatures according to the present invention.

In another example according to the present invention a customer i.e. user browses the Internet and comes across an advertisement picture of a content provider e.g. a flower shop. The user reads the advertisement of the flower shop. The advertisement presents a special offer to the user e.g. that a small oak tree 30 cm tall is for sale for $10.

Having read the advertisement of the flower shop the user can select the interesting offer by clicking on a button in the terminal device e.g. personal computer. Content provider i.e. the flower shop then presents a picture with a a contract for the purchasing of the product i.e. the requested tree. The contract picture can e.g. present a description of the purchased product and the terms of the sale of the product.

Having read the contract picture of the flower shop the user then accepts the purchasing contract by signing the read contract picture. So the user buys the advertised offer i.e. the tree by signing the picture file having the description of a tree. Signing can be done e.g. by entering his personal pin code.

Having received the user acceptance, the content provider sends the signed picture file and the charged amount in machine-readable format to a payment provider. The content provider can also send to the payment provider a pointer to a picture together with the charged amount. The signature of the user i.e. the personal pin code is sent and stored beforehand at the payment provider. The payment provider then provides a payment to the content provider, and accordingly the content provider then provides the purchased product i.e. the tree to the user.

If the purchased product i.e. the tree delivered now diverge from the tree in the picture the user can complain as the message describes what he has bought.

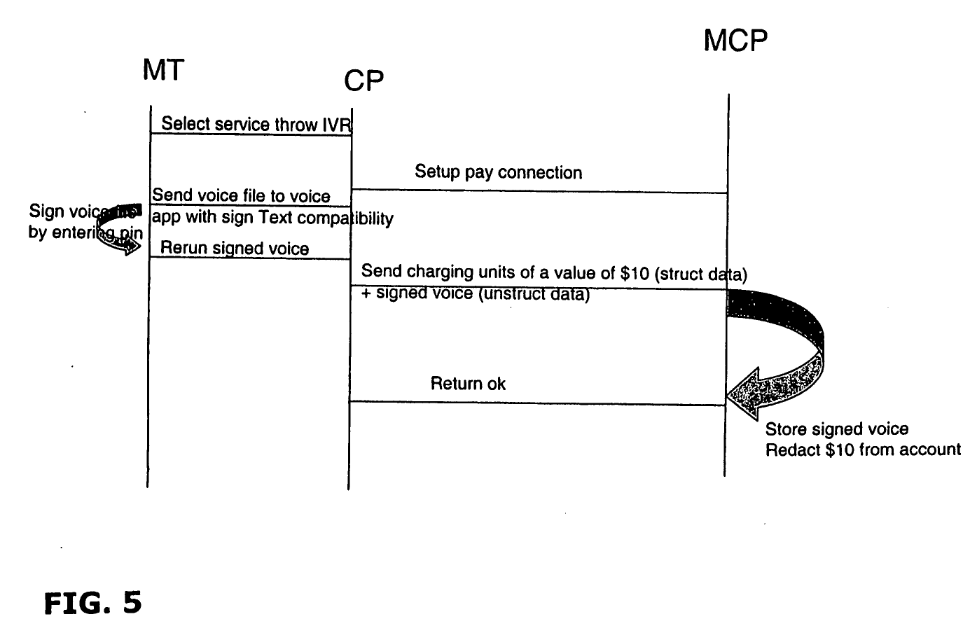

FIG. 5 illustrates a signalling diagram of one embodiment of the solution for verifying electronic signatures according to the present invention. In the figure an example is presented with three parties listed, a user having a Mobile Terminal (MT), a Content Provider (CP), and a Mobile Commerce Platform (MCP) as the payment provider for the user.

In the example according to the present invention the user having a mobile terminal (MT) calls the content provider (CP). The user listens to or reads an advertisement of the content provider (CP).

Having listened or read the advertisement of the content provider (CP) the user having a mobile terminal (MT) selects a service e.g. through IVR (IVR, Interactive Voice Response) by clicking on a button in the phone terminal.

Content provider (CP) then sets up a payment connection with the Mobile Commerce Platform (MCP), which acts as the payment provider for the user. The signature of the user i.e. the personal pin code is sent and stored beforehand at the payment provider.

Content provider (CP) then presents a contract for the purchasing of the product in the form of e.g. a recorded voice file. The contract recording can e.g. present a description of the purchased product and the terms of the sale of the product.

Having listened the contract in the form of a recorded voice file the user then accepts the purchasing contract by signing the listened contract recording. Signing can be done e.g. by entering his personal pin code. The user having a mobile terminal (MT) then returns the signed contract e.g. signed voice file to the content provider (CP).

Having received the user acceptance, the content provider (CP) sends the signed voice file and the charged amount in machine-readable format (structured data) to the payment provider (MCP). The payment provider (MCP) stores the signed voice file and redacts the charged amount from the account of the user. The payment provider then provides a payment to the content provider (CP), and accordingly the content provider (CP) then provides the purchased product to the user.

The solution according to the present invention can for example be used together with a mobile phone handsfree device. The mobile phone handsfree device can be complemented with PKI signature functionality (PKI, Public Key Infrastructure). With this functionality, the mobile phone can be used as a communication channel and MP3 files as means to communicate contract information.

The solution according to the present invention can also be used together with different media players, such as music players. These music players can be complemented with some local communication protocol e.g. Bluetooth or IrDa and PKI signing functionality. In these applications, the signature device could be used locally, e.g. in point-of-sales or vending machine.

An example of the use of the solution according to the present invention is for example a blind end-user buying a soft drink from a vending machine. The user uses his/her mobile phone and MP3 handsfree to pay the drink. The payment contract is then presented to the user e.g. in a form of a song. The user listens the song that contains the contract and signs it. Data file is sent to the verification center, which informs the vending machine that the payment has been accomplished. User receives his/her soft drink.

The solution according to the present invention provides additional flexibility and is still providing a simple solution in which also unstructured data can be used and utilized.

The solution according to the present invention can be used in various types of systems ranging from electronic purchases to securing important electronic contracts and transactions.

1. A method for verifying electronic signatures, the method having a signatory with a terminal device, a content provider, and a payment provider for the signatory, characterized in that the signatory signs data files containing unstructured electronic data presenting a contract in the form of one or a combination of at least two of the elements of voice, still picture, moving picture and unstructured text.

2. A method according to claim 1, characterized in that the method comprises the steps of
the content provider presenting said data files to the signatory,
the signatory accepting the contract by signing said data files,
the signatory returning the signed data files to the content provider,
the content provider sending the signed data files together with the charged amount in structured machine-readable format to the payment provider, and
the payment provider storing the signed data files and redacting the charged amount from the account of the user.

3. A method according to claim 2, characterized in that prior to having the contract presented the signatory listens to or reads an advertisement of the content provider and selects a service with his terminal device.

4. A method according to claim 2, characterized in that prior to having the contract presented the content provider sets up a payment connection with the payment provider.

5. A method according to claim 2, characterized in that the content provider sends the unstructured data and the structured data combined together to the payment provider.

6. A method according to claim 2, characterized in that the content provider sends the unstructured data and the structured data linked together to the payment provider.

7. A method according to claim 6, characterized in that the structured data has a pointer to the unstructured data.

8. A method according to claim 6, characterized in that the content provider sends the unstructured data and the structured data in separate messages to the payment provider.

9. A method according to claim 6, characterized in that the content provider stores unstructured data and only sends the structured data to the payment provider.

10. A method according to claim 1, characterized in that the verifier of the signature is the original source of the data that is signed.

11. A method according to claim 1, characterized in that the signatory interprets the content of the unstructured data before signing.

12. A method according to claim 11, characterized in that the signatory applies the electronic signature over unstructured data files.

13. A method according to claim 11, characterized in that the signatory applies the electronic signature over unstructured data files and additional attributes.

14. A method according to claim 11, characterized in that the signatory applies the electronic signature over unstructured data files and structured data files.

15. A method according to claim 12, characterized in that the signatory applies the electronic signature using a private signature key.

16. A method according to claim 12, characterized in that the signatory applies the electronic signature using a mobile device.

17. A method according to claim 12, characterized in that the signatory applies the electronic signature using a personal computer.

18. A method according to claim 12, characterized in that the signatory applies the electronic signature using television equipment.

19. A system for verifying electronic signatures, the system having a signatory with a terminal device, a content provider, and a payment provider for the signatory, characterized in that the system has an electronic signature device equipped for the signatory to sign data files containing unstructured electronic data presenting a contract in the form of one or a combination of at least two of the elements of voice, still picture, moving picture and unstructured text.

20. A system according to claim 19, characterized in that the system has:
means for the content provided to present said data files to the signatory,
means for the signatory to accept the contract by signing said data files,
means for the signatory to return the signed data files to the content provider,
means for the content provider to send the signed data files together with the charged amount in structured machine-readable format to the payment provider,
means for the payment provider to store the signed data files and to redact the charged amount from the account of the user.

21. A system according to claim 20, characterized in that the system has means for the signatory to listen to or to read an advertisement of the content provider and to select a service with his terminal device prior to having the contract presented.

22. A system according to claim 20, characterized in that the system has means for the content provider to set up a payment connection with the payment provider prior to having the contract presented.

23. A system according to claim 20, characterized in that the system has means for the content provider to send the unstructured data and the structured data combined together to the payment provider.

24. A system according to claim 20, characterized in that the system has means for the content provider to send the unstructured data and the structured data linked together to the payment provider.

25. A system according to claim 24, characterized in that the structured data has a pointer to the unstructured data.

26. A system according to claim 24, characterized in that the system has means for the content provider to send the unstructured data and the structured data in separate messages to the payment provider.

27. A system according to claim 24, characterized in that the system has means for the content provider to store unstructured data and only to send the structured data to the payment provider.

28. A system according to claim 19, characterized in that the verifier of the signature is the original source of the data that is signed.

29. A system according to claim 19, characterized in that the unstructured data files that are to be signed are stored into the Contract Database.

30. A system according to claim 19, characterized in that the unstructured data files that are to be signed are stored on Service Platform.

31. A system according to claim 19, characterized in that the system has means for the signatory to interpret the content of the unstructured data before signing.

32. A system according to claim 31, characterized in that the unstructured data files are sent to the signatory via a mobile network.

33. A system according to claim 31, characterized in that the unstructured data files are sent to the signatory via Internet.

34. A system according to claim 31, characterized in that the unstructured data files are sent to the signatory via a television network.

35. A system according to claim 31, characterized in that the unstructured data files are sent to the signatory via a Wireless Local Area Network.

36. A system according to claim 31, characterized in that the unstructured data files are sent to the signatory via a Bluetooth connection.

37. A system according to claim 31, characterized in that the unstructured data files are sent to the signatory via an IrDa connection.

38. A system according to claim 31, characterized in that the unstructured data files are presented to the signatory via a media player.

39. A system according to claim 38, characterized in that the media player is complemented with Bluetooth functionality.

40. A system according to claim 38, characterized in that the media player is complemented with IrDa functionality.

41. A system according to claim 31, characterized in that the signatory applies the electronic signature over unstructured data files.

42. A system according to claim 31, characterized in that the signatory applies the electronic signature over unstructured data files and additional attributes.

43. A system according to claim 31, characterized in that the signatory applies the electronic signature over unstructured data files and structured data files.

44. A system according to claim 31, characterized in that the signatory applies the electronic signature using a private signature key.

45. A system according to claim 31, characterized in that the signature verifier has interpretation/validation means for interpreting and validating the signed contract.

46. A system according to claim 31, characterized in that the signature verifier has informing means to inform the Service Platform about the status of the contract.

47. A system according to claim 31, characterized in that the signature verifier has reporting means to inform the signatory about the validation of the contract.

48. A system according to claim 31, characterized in that the signatory applies the electronic signature using a mobile device.

49. A system according to claim 31, characterized in that the signatory applies the electronic signature using a personal computer.

50. A system according to claim 31, characterized in that the signatory applies the electronic signature using television equipment.

51. An electronic signature device for signing electronic signatures in a system for verifying electronic signatures, the system having a signatory with a terminal device, a content provider, and a payment provider for the signatory, characterized in that the electronic signature device is equipped for the signatory to sign data files containing unstructured electronic data presenting a contract in the form of one or a combination of at least two of the elements of voice, still picture, moving picture and unstructured text.

52. A device according to claim 51, characterized in that the verifier of the signature is the original source of the data that is signed.

53. A device according to claim 51, characterized in that the device has means for the signatory to interpret the content of the unstructured data before signing.

54. A device according to claim 53, characterized in that the unstructured data files are sent to the signatory via a mobile network.

55. A device according to claim 53, characterized in that the unstructured data files are sent to the signatory via Internet.

56. A device according to claim 53, characterized in that the unstructured data files are sent to the signatory via a television network.

57. A device according to claim 53, characterized in that the unstructured data files are sent to the signatory via a Wireless Local Area Netowrk.

58. A device according to claim 53, characterized in that the unstructured data files are sent to the signatory via a Bluetooth connection.

59. A device according to claim 53, characterized in that the unstructured data files are sent to the signatory via an IrDa connection.

60. A device according to claim 53, characterized in that the device has an integrated media player for presenting the unstructured data files to the signatory.

61. A device according to claim 60, characterized in that the media player is complemented with Bluetooth functionality.

62. A device according to claim 60, characterized in that the media player is complemented with IrDa functionality.

63. A device according to claim 53, characterized in that the signatory applies the electronic signature over unstructured data files.

64. A device according to claim 53, characterized in that the signatory applies the electronic signature over unstructured data files and additional attributes.

65. A device according to claim 53, characterized in that the signatory applies the electronic signature over unstructured data files and structured data files.

66. A device according to claim 53, characterized in that the signatory applies the electronic signature using a private signature key.

67. A device according to claim 53, characterized in that the device is a mobile terminal.

68. A device according to claim 67, characterized in that the device is complemented with a mobile hands free device.

69. A device according to claim 53, characterized in that the device is implemented in a mobile handsfree device.
